(19) United States
(12) Patent Application Publication
(10) Pub. No.: US 2023/0111036 A1
(43) Pub. Date: Apr. 13, 2023

(54) INTEGRATED DRILLING DYSFUNCTION PREDICTION

(71) Applicant: Pioneer Natural Resources USA, Inc., Irving, TX (US)

(72) Inventors: Jingshuang Xue, Frisco, TX (US); Vikram Jayaram, Dallas, TX (US); Omkar Ramesh Malepati, Irving, TX (US); Sercan Gul, Irving, TX (US); Jonathan James Wilson, Little Elm, TX (US); Scotty Ray Reyna, McKinney, TX (US); Cathryn Mariah Hart, Irving, TX (US); Gabriel Diaz, Flower Mound, TX (US); Austin Jeske, Flower Mound, TX (US); Dev Raj Kumar, Dallas, TX (US)

(21) Appl. No.: 17/450,643

(22) Filed: Oct. 12, 2021

(51) Int. Cl. G06N 3/04; G06N 3/08; E21B 47/06; E21B 47/10

(52) U.S. Cl. CPC G06N 3/0427; G06N 3/08; E21B 47/06; E21B 47/10; E21B 2200/22; E21B 2200/20

(57) ABSTRACT

A computer system, computer, and method for converting time series real-time drilling data to a drilling dysfunction prediction, utilizing machine learning layered on top of deep learning with data processing and trend analysis therebetween.

### FIELD OF THE DISCLOSURE

This disclosure relates to the drilling of wellbores in an unconventional subsurface, and more particularly, to the data science and engineering framework of predicting drilling dysfunctions.

### BACKGROUND

When drilling a wellbore in an unconventional subsurface, drilling dysfunctions can occur. Nonlimiting examples of drilling dysfunctions can include drillstring failure due to material fatigue, washout or excessive torque, problems associated with tripping the drillstring, wellbore instability, stuck pipe, and stuck debris in the wellbore or drillstring that affects performance and safety. Many drilling operations are reactive in nature to drilling dysfunctions, in that, the dysfunctions are detected, and then action is taken to remedy the type of dysfunction. For example, a stuck pipe can occur in a horizontally-oriented wellbore in unconventional drilling operations. These locations are usually far from the surface of the earth, so reactive action involves accessing the stuck pipe, working operational procedures to free the pipe, removing the pipe from the wellbore, and repairing any wellbore and drillstring damage done by the forces that caused the pipe to get stuck and to free and remove the pipe from the wellbore. Each stuck pipe incident sharply decreases drilling efficiency and results in high operational expenses involving workover crew, replacing equipment, non-productive time and sometimes environmental hazards.

In an effort to predict drilling dysfunction, rig operators and engineers can visually monitor the streaming output of historical and real-time drilling data for various drilling parameters (e.g., surface standpipe pressure, drilling fluid flow rate, drillstring rotations per minute, drillstring speed, drillstring vibration, hook load, or combinations thereof) and make decisions based on the visually perceived streaming output using their experience and intuition. The streaming output for each drilling parameter may have a separate screen, so an engineer needs to monitor multiple real-time drilling parameter graphs across multiple displays or screens on a continuous basis for multiple wells, which can be exhausting and is susceptible to human error due to missing sudden fluctuations in data values and misinterpretation.

There is an ongoing need to provide automated monitoring of real-time drilling data.

### SUMMARY

Disclosed is a method for converting time series real-time drilling data into a dysfunction prediction of a downhole characteristic in a wellbore environment. The method can include receiving or retrieving a first stream comprising the time series real-time drilling data; performing a machine-learning model on the first stream to obtain rig states and to output a second stream comprising the time series real-time drilling data and the rig states; preprocessing the second stream to obtain a third stream comprising cleaned rig data and the rig states; determining trends of at least one drilling parameter in the third stream to obtain a fourth stream of trend analysis data comprising trend statuses, the cleaned rig data, and the rig states; generating a time segmented drilling data batch comprising the trend analysis data received over a window of time; and performing a deep learning model on the time segmented drilling data batch to obtain the dysfunction prediction and to output a fifth stream comprising the dysfunction prediction of the downhole characteristic associated with the wellbore environment.

Also disclosed is a method comprising receiving or retrieving a first stream comprising the time series real-time drilling data; performing a machine-learning model on the first stream to obtain rig states and to output a second stream comprising the time series real-time drilling data and the rig states; preprocessing the second stream to obtain a third stream comprising cleaned rig data and the rig states; determining trends of at least one drilling parameter in the third stream to obtain a fourth stream of trend analysis data comprising trend statuses, the cleaned rig data, and the rig states; sending a first indicator, a second indicator, and a third indicator for the at least one drilling parameter or the wellbore characteristic to a user device, wherein the first indicator is indicative of a value of the at least one drilling parameter or wellbore characteristic, wherein the second indicator is indicative of the severity of the value of the at least one drilling parameter or wellbore characteristic, and wherein the third indicator indicative of the rig state; wherein the first indicator, the second indicator, and the third indicator are visually depicted on a graph that is displayed on the user device, wherein the first indicator is a data point on the graph, and the second indicator is a color or pattern of the data point, and the third indicator is an outline of the data point.

Also disclosed herein is a method that can include determining a severity of a dysfunction prediction of a downhole characteristic, and sending a first indicator and a second indicator for the dysfunction prediction to a user device, wherein the first indicator is indicative of a value of the dysfunction prediction associated with the window of time and the second indicator is indicative of the severity of the dysfunction prediction associated with the window of time. The first indicator and the second indicator can be visually depicted on a graph that is displayed on the user device, wherein the first indicator is a data point on the graph, and the second indicator is a color or pattern of the data point. The method can also include sending a third indicator indicative of the rig state to the user device, wherein the third indicator is visually depicted on the graph as an outline of the data point. The dysfunction prediction can be obtained, for example, by a technique disclosed herein.

Also disclosed is a computer system that can include a first computer device configured to: receive or retrieve a first stream comprising the time series real-time drilling data; perform a machine-learning model on the first stream to obtain rig states and to output a second stream comprising the time series real-time drilling data and the rig states; preprocess the second stream to obtain a third stream comprising cleaned rig data and the rig states; determine trends of at least one drilling parameter in the third stream to obtain a fourth stream of trend analysis data comprising trend statuses, the cleaned rig data, and the rig states; generate a time segmented drilling data batch comprising the trend analysis data received over a window of time; and perform a deep learning model on the time segmented drilling data batch to obtain the dysfunction prediction and to output a fifth stream comprising the dysfunction prediction of the downhole characteristic associated with the wellbore environment.

Also disclosed is a computer system that can include a first computer device configured to: receive or retrieve a first stream comprising the time series real-time drilling data; perform a machine-learning model on the first stream to obtain rig states and to output a second stream comprising the time series real-time drilling data and the rig states; preprocess the second stream to obtain a third stream comprising cleaned rig data and the rig states; determine trends of at least one drilling parameter in the third stream to obtain a fourth stream of trend analysis data comprising trend statuses, the cleaned rig data, and the rig states; send a first indicator, a second indicator, and a third indicator for the at least one drilling parameter or the wellbore characteristic to a user device, wherein the first indicator is indicative of a value of the at least one drilling parameter or wellbore characteristic, wherein the second indicator is indicative of the severity of the value of the at least one drilling parameter or wellbore characteristic, and wherein the third indicator indicative of the rig state; wherein the first indicator, the second indicator, and the third indicator are visually depicted on a graph that is displayed on the user device, wherein the first indicator is a data point on the graph, and the second indicator is a color or pattern of the data point, and the third indicator is an outline of the data point.

Also disclosed is a computer system that can include a first computer device configured to: determine a severity of a dysfunction prediction of a downhole characteristic, and send a first indicator and a second indicator for the dysfunction prediction to a user device. The first indicator is indicative of a value of the dysfunction prediction associated with the window of time and the second indicator is indicative of the severity of the dysfunction prediction associated with the window of time. The first indicator and the second indicator can be visually depicted on a graph that is displayed on the user device, wherein the first indicator is a data point on the graph, and the second indicator is a color or pattern of the data point. The first computer device can be further configured to send a third indicator indicative of the rig state to the user device, wherein the third indicator is visually depicted on the graph as an outline of the data point. The dysfunction prediction can be obtained, for example, by a technique disclosed herein.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 illustrates a block diagram of a computing system according to the disclosure.

FIG. 2 illustrates a block diagram of software executed by the dysfunction prediction computer according to the disclosure.

FIG. 3 illustrates a graph of values for a drilling parameter versus time for a wellbore environment, having data points displayed in a simplified manner according to the disclosure.

FIG. 4 illustrates a graph of predicted dysfunction value versus time for a wellbore environment, having data points displayed in a simplified manner according to the disclosure.

FIG. 5 illustrates a flow diagram of the disclosed method.

FIG. 6 illustrates a flow diagram of optional steps of the method that can be performed after the output data-set or a stream of output data is generated.

FIG. 7 illustrates a flow diagram of optional steps of the method that can be performed before the modules of the drilling dysfunction prediction computer receive or retrieve the time series real-time drilling data.

### DETAILED DESCRIPTION

It should be understood at the outset that although an illustrative implementation of one or more embodiments are provided below, the disclosed computer system, computer, and/or method may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

“Wellbore environment” as used herein refers to the collective reference to a drilling rig, the equipment associated with the drilling rig that is used to drill a wellbore, the subsurface formation, the wellbore that is formed in the subsurface formation, fluid(s) in the subsurface formation, fluid(s) in the wellbore, fluid(s) in the pipe/drillstring, and characteristics of the rig, equipment, pipe/drillstring, subsurface formation, and wellbore that collectively contribute to define the environment in which drilling is performed. The wellbore can be onshore and conventional or unconventional.

“Rig state” as used herein refers to a state/activity of the drilling rig. It has two super rig states: tripping and drilling. The sub rig states under those super rig states include but are not limited to rotary drilling, slide drilling, tripping in, tripping out, circulating, connection, static, washing, pulling out of the hole, running in the hole, reaming up, and reaming down.

“Downhole characteristic” as used herein refers to any characteristic of a wellbore environment, such as but not limited to drilling state (e.g., tripping, drilling, etc.), drillstring temperature, drillstring pressure, drillstring vibration, drillstring loads (static and dynamic forces), drill bit status, wellbore temperature, wellbore pressure, and drilling fluid flowrate.

“Drilling dysfunction” as used herein refers to a state of drilling operations that leads to stoppage of normal drilling operations due to a dysfunction associated with a downhole characteristic. Nonlimiting examples of “drilling dysfunction” include a drillstring failure due to material fatigue, washout or excessive torque, problems associated with tripping the drillstring, wellbore instability (which could lead to collapse), stuck pipe, and stuck debris in the wellbore or in the drillstring that affects fluid flow.

“Drilling dysfunction prediction” as used herein refers to an indicator (e.g., numerical value) that is indicative of the likelihood or probability of an occurrence of a drilling dysfunction. For example, the drilling dysfunction prediction can be a numerical value that is indicative of the likelihood that the drilling dysfunction will occur, for example, indicated as a numerical value from 0 to 1 or 0 to 10 or 0 to 100; alternatively, indicated as a percentage from 0% to 100%.

“Accuracy of drilling dysfunction prediction” or “drilling dysfunction prediction accuracy” as used herein refers to the number of true positives determined by the technique disclosed herein. An accuracy of 60% means that 6 out of every 10 predictions of drilling dysfunction are true, an accuracy of 70% means that 7 out of every 10 predictions of drilling dysfunction are true, and so on.

Disclosed are a computer system, drilling dysfunction prediction computer, and method for converting time series real-time drilling data into a drilling dysfunction prediction of a downhole characteristic in a wellbore environment. The disclosed computer system, drilling dysfunction prediction computer, and method utilize a machine learning model layered on top of a deep learning model in order to convert time-series real-time drilling data into the drilling dysfunction prediction. Particularly, the machine learning model obtains a rig state. The rig state is then pre-processed with the time-series real-time drilling data and subjected to trend analysis of drilling parameters based on the rig state. A trend status that is obtained by the trend analysis, along with a time segmented drilling data batch of the time series real-time drilling data, are then processed by the deep learning model to obtain the drilling dysfunction prediction. The drilling dysfunction prediction and/or predicted values of drilling parameter(s) and/or wellbore characteristic(s) can be subject to severity mapping, and subsequently indicators of predicted value, severity, and super rig states can be sent for viewing on a screen of user device. The accuracy of proposed drilling dysfunction prediction is higher than any techniques currently available.

Conventionally, engineers visually monitor a streaming output of real-time drilling data for various drilling parameters (e.g., surface standpipe pressure, drilling fluid flow rate, drillstring rotations per minute, drillstring speed, drillstring vibration, hook load, or combinations thereof), to try to foresee a drilling dysfunction such as a stuck pipe, based on the visually perceived streaming output using their experience and intuition. Without being limited by theory, when implementing a computerized prediction of drilling dysfunction using drilling parameters and wellbore characteristics according to the techniques disclosed herein, it has been found that determining the rig state with a machine learning model, analyzing trends on drilling parameters and/or wellbore characteristics, and then using the rig state and trends as inputs for a deep learning model that determines a drilling dysfunction prediction more accurately predicts dysfunction at a future time compared with conventional monitoring techniques and with currently available computerized techniques that do not utilize layered machine learning and deep learning models and that do not determine and utilize a rig state with the models. That is, it has been found that, since the signatures of streaming data are different for different rig states (e.g., tripping signature is different than drilling signature), rig states are key to calculating real-time key performance indicators (KPIs) for drilling operations, and dysfunction predictions are more accurate when using a machine learning model to determine rig state before performing a deep learning model on the streaming data along with the rig states to determine the predicted dysfunction.

Moreover, it has been found that converting streaming rig states and trends to a time segmented drilling data batch for input to the deep learning model over a window of time as disclosed herein improves processing for the deep learning model because the data is converted to a format that allows fast insertion into the deep learning model and/or fast retrieval by the deep learning model to support the complexity of neural network data processing that occurs in the deep learning model. The fast insertion and/or retrieval improves processing speed and reduces processing burden for the large volume of data that is characteristic in wellbore environments.

Moreover, there is conventionally no way to view the predicted severity of a drilling parameter value, and the disclosed severity determination for the deep learning predictions provides a user the ability to view a predicted value of a drilling parameter, a predicted severity of that value, and the super rig state associated with the predicted value, all in a single screen and on a single data point of drilling parameter data. This viewing technique enables skilled or unskilled personal to view and easily determine whether action needs to be taken, and the viewing can be made via an application running on a mobile device, such as a smartphone or tablet.

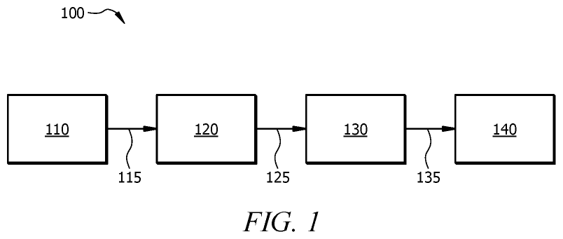

FIG. 1 illustrates a block diagram of a computer system 100 according to the disclosure. The computer system 100 of FIG. 1 provides an integrated real-time solution for receiving or retrieving drilling data, processing the drilling data, and predicting dysfunction of wellbore characteristics in the wellbore environment. The computer system 100 can include one or more of a drilling data computer system 110, a drilling database 120, a drilling dysfunction prediction computer 130, and a user device 140. The drilling data computer system 110 can be networked with the drilling database 120, the drilling database 120 can additionally be networked with the drilling dysfunction prediction computer 130, and the drilling dysfunction prediction computer 130 can additionally be networked with the user device 140.

Each of the components 110, 120, 130, and 140 shown in FIG. 1 can be embodied with computer equipment such as one or more processors, memory, networking cards or interfaces, and other equipment for receiving, processing, and sending data according to the functionality described herein. The hardware of the drilling dysfunction prediction computer 130, in particular, includes one or more graphics processing units (GPUs) in order to perform the machine learning model layered on top of the deep learning model on the volume of time-series real-time drilling data flowing through the drilling dysfunction prediction computer 130 and computer system 100.

The networking between any two of components 110, 120, 130, and 140 of the computer system 100 can be embodied as any wired internet connection, wireless internet connection, local area network (LAN), wired intranet connection, wireless intranet connection, or combinations thereof. Wireless internet connections can include a Global System for Mobile Communications (GSM), Code-division multiple access (CDMA), General Packet Radio Service (GPRS), Evolution-Data Optimized (EV-DO), Enhanced Data Rates for GSM Evolution (EDGE), Universal Mobile Telecommunications System (UMTS), or combinations thereof.

The drilling data computer system 110 generally includes sensors, computer(s), and networking infrastructure that are configured to monitor and record drilling operations associated with a drilling rig at a well-site. The sensors are generally coupled to the computer and configured to send signals in real-time representing the wellbore and drilling parameters to the computer. Signals for the wellbore characteristics and drilling parameters that can be sensed and collected by the drilling data computer system 110 can include signals for wellbore fluid (e.g., mud) flow rate, fluid density, fluid viscosity, differential pressure, standpipe pressure, block height, block speed, hook load, weight on bit, pipe rotary speed, torque, or combinations thereof.

The computer of the drilling data computer system 110 can generally include one or more processors and one or more memory having instructions stored thereon that cause the one or more processors to receive and detect the real-time signals from the sensors. The computer of the drilling data computer system 110 is configured to convert the signals to data values associated with particular wellbore and drilling parameters and apply a time stamp to each data value for each parameter. The computer of the drilling data computer system 110 is also configured to send the data values of the wellbore and drilling parameters that are time stamped to the drilling database 120 as a stream 115 of data that is referred to herein as time series real-time drilling data. The format of the data values in the time series real-time drilling data can be any format known in the art with the aid of this disclosure, such as XML Format, the Wellsite Information Transfer Standard Markup Language (WITSML) Format, Hierarchical Data Format (HDF), Excel Format, Java Script Object Notation (JSON), Statistical Package for the Social Sciences (SPSS), or combinations thereof

In some optional aspects, the computer of the drilling data computer system 110 can be configured to also send the stream 115 of the time series real-time drilling data to the drilling dysfunction prediction computer 130 or to allow the drilling dysfunction prediction computer 130 to retrieve time series real-time drilling data from the one or more datastores.

The drilling database 120 is a real-time drilling database configured to store the stream 115 of time series real-time drilling data that is received from the drilling data computer system 110 in any format known in the art with the aid of this disclosure. The drilling database 120 can generally include one or more processors, one or more datastores, and one or more memory having instructions stored thereon that cause the one or more processors to store the time series real-time drilling data in the one or more datastores. The drilling database 120 can be located entirely in the cloud, partially in the cloud (e.g., having portions on the edge and/or in locally stored datastore), or entirely local.

The drilling database 120 can be configured to send a stream 125 of the time series real-time drilling data to the drilling dysfunction prediction computer 130 or to allow the drilling dysfunction prediction computer 130 to retrieve time series real-time drilling data from the one or more datastores. In embodiments, the drilling database 120 simultaneously stores the stream 115 of the time series real-time drilling data in the one or more datastores and sends the stream 125 to the drilling dysfunction prediction computer 130.

Drilling dysfunction prediction computer 130 is configured to receive or retrieve the stream 125 of time series real-time drilling data from the drilling database 120 (or receive or retrieve the stream 115 of time series real-time drilling data from the drilling data computer system 110) and to send a drilling dysfunction prediction(s) 135 to the user device 140. The drilling dysfunction prediction computer 130 can generally include one or more processors, one or more datastores, and one or more memory having instructions stored thereon that cause the one or more processors to process the stream 115 or 125 of time series real-time drilling data such that the time series real-time drilling data is converted to a stream 135 containing one or more of i) drilling dysfunction predictions, iii) rig state for each time point, iii) trend status for each time point, iv) the time series real-time drilling data that was processed to obtain the drilling dysfunction predictions, v) severity levels, vi) alerts, and vii) any other data discussed herein, according to the technique described in more detail herein.

The user device 140 is configured to receive the stream 135 from the drilling dysfunction prediction computer 130. The user device 140 can be embodied as a desktop computer, laptop computer, tablet, smartphone, or combinations thereof. The user device 140 generally has one or more processors and one or more memory having instructions stored thereon that cause the user device 140 to receive the stream 135 and to display indicators (e.g., drilling parameter or wellbore characteristic value, severity and rig state as described in detail herein) on a screen or display of the user device 140 for visual observation by any drilling operations personnel.

In embodiments, the user device 140 can store received data for historical retrieval when viewing drilling parameter and/or wellbore characteristic data at a future time. In such embodiments, a graph can be retrieved having historical drilling parameter and/or wellbore characteristic data as well as drilling dysfunction predictions.

In some embodiments, the user device 140 can have a dashboard on a display by which a user can view and select one or more drilling rigs to receive the alerts and view graphs as described herein. The severity level can be displayed in the dashboard, or a link to a graph having the severity level can be included on the dashboard, and the user can navigate the dashboard to advance the screen to the graph. Via the received data at the user device 140, the dashboard displayed on the user device 140 can allow a user to interpret real-time severity levels of drilling parameter and/or wellbore characteristic data values, view historical drilling parameter and/or wellbore characteristic data values, select drilling parameter and/or wellbore characteristic data (e.g. key performance indicators) to view, select the time range for which the drilling parameter and/or wellbore characteristic data are to be viewed, and select the rig(s) for which the drilling parameter and/or wellbore characteristic data are to be viewed.

Third party user devices 140 can be integrated with the drilling dysfunction prediction automated framework 130 to view drilling parameter and/or wellbore characteristic data values in real-time, an indication of severity of any dysfunction, and an indication of the trend status, all on a single easy to view and interpret display on the user device 140.

Moreover, in response to viewing drilling parameter and/or wellbore characteristic data values in real-time, an indication of severity of any dysfunction at future times, an indication of the rig state, and an indication of the trend status, the user of the user device 140 can pause or make an adjustment to a drilling parameter so as to get out of drilling dysfunction (e.g., reduce or stop fluid flow, reduce or stop drillstring rotation, start or stop tripping, etc.).

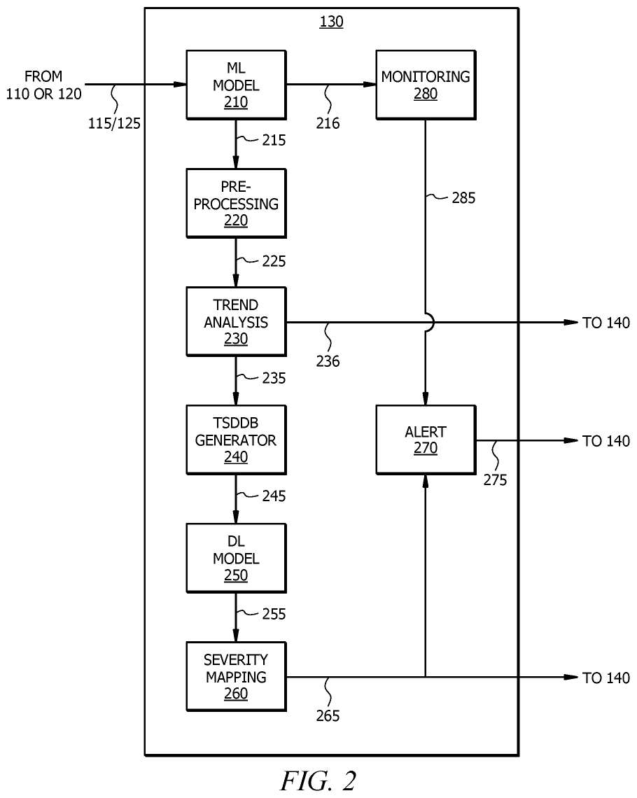

FIG. 2 illustrates a block diagram of software executed by the drilling dysfunction prediction computer 130 according to the disclosure. It should be appreciated that other software not described herein may be contained on and executed by the dysfunction prediction computer 130; alternatively, the software described herein is the only software contained on and executed by the drilling dysfunction prediction computer 130.

As can be seen, the drilling dysfunction prediction computer 130 has multiple modules, including a machine learning (ML) module 210, a data processing module 220, a trend analysis module 230, a time segmented drilling data batch (TSDDB) generator module 240, a neural network module 250, a severity mapping module 260, an alert module 270, and a monitoring module 280.

The stream 115/125 of time series real-time drilling data is received or retrieved by the drilling dysfunction prediction computer 130 for processing.

The machine learning module 210 is configured to perform a machine-learning model on the stream 115/125 of time series real-time drilling data to determine rig states. Each determined rig state corresponds to a data point the same point in time in the stream 115/125 of time series real-time drilling data. For example, in an embodiment where the stream 115/125 of time series real-time drilling data includes data values measured every 1 second (one or more drilling parameter data values for Aug. 1, 2021 at 8:00:00 pm and one or more drilling parameter data values for Aug. 1, 2021 at 8:00:01 pm), the rig states contain a corresponding rig state value for every 1 second of measured time series real-time drilling data (e.g., the rig state for Aug. 1, 2021 at 8:00:00 pm and the rig state for Aug. 1, 20201 at 8:00:01 pm).

The machine-learning model in the machine learning module 210 can include decision tree-based machine learning model to determine the rig states. This tree-based model uses a series of if-then rules to generate predictions from one or more decision trees using major drilling parameters such as but not limited to bit depth, hole depth, rotations per minute, and fluid (e.g., mud) flow rate. For example, if the bit depth is not equal to hole depth, the bit depth decreases with no rotation and no flow rate, the rig state is determined to be pulling out of the hole.

The drilling dysfunction prediction computer 130 is configured to send a stream 215 of the time series real-time drilling data with the rig states for each time point from the machine learning module 210 to the data processing module 220. In some additional aspects, the drilling dysfunction prediction computer 130 is configured to send a stream 216 of time series real-time drilling data with the rig states for each time point from the machine learning module 210 to the monitoring module 280. In such aspects, the stream 216 of rig states is a duplicate of the stream 215 of rig states, or vice versa.

The data processing module 220 is configured to receive the stream 215 of rig states from the machine learning module 210 and to preprocess the received stream 215 so as to provide quality control/quality analysis (QC/QA) on the received data for input of a stream 225 of cleaned rig data into the trend analysis module 230. Preprocessing performed by the data processing module 220 can include capping minimum value of a drilling parameter, capping a maximum value of a drilling parameter, filling a gap (a missing value) in the time series values for a drilling parameter, removing an impossible value for a drilling parameter, ignoring any data carried over from the last well based on hole depth, normalizing data values between 0 and 1, or combinations thereof, to produce the stream 225 of cleaned rig data.

The cleaned rig data can include the cleaned time series real-time drilling data and rig state associated with each data point in the time series real-time drilling data.

The trend analysis module 230 is configured to receive the stream 225 of cleaned rig data and to determine one or more trends of at least one drilling parameter in the stream of cleaned rig data to obtain a stream 235 of trend analysis data containing trend statuses. The trend analysis module 230 can also be configured to obtain a stream 236 of the trend analysis data and the cleaned time series real-time drilling data. A trend generally includes the change in the value of a drilling parameter at a point in time relative to one or more other values for the drilling parameter at other points in time.

The trend status is indicative of the one or more trends of at least one drilling parameter. In embodiments, a trend status can be binary, such as normal or abnormal. In other embodiments, the trend status can be assigned a value on a scale, such as 1, 2, 3, 4, 5, 6, 7, 8, 9, or 10, with 1 being indicative of a normal operation and 10 being indicative of abnormal operation. The trend status can have other values, and the foregoing examples are intended to be nonlimiting.

To determine trends, the trend analysis module 230 can identify or calculate at least one drilling parameter for each point in the stream 225 of cleaned rig data. For example, the trend analysis module 230 can identify or calculate values for drilling parameters of standpipe pressure, hook load, torque, fluid flow rate, or a combination thereof at each time point. The trend analysis module 230 can then determine a trend for each drilling parameter. The trend may be that the drilling parameter is increasing at a calculated rate, or decreasing at a calculated rate, or not changing.

To determine trend status, the drilling dysfunction computer 130 (e.g., via the trend analysis module 230) can be loaded with threshold trend values chosen for the wellbore environment, and the trend analysis module 230 can compare the threshold trend value with the determined trend value for each data point of the drilling parameter. If the difference between the determined trend value and the threshold trend value is beyond a corresponding tolerance, then the trend analysis module 230 can assign a trend status of the drilling rig to be abnormal based on the out of tolerance trend. For example, if the trend for standpipe pressure is that the pressure is increasing as a trend faster than tolerance, the increase in pipe pressure may be indicative of a future occurrence of a stuck pipe or other drilling dysfunction, and the trend analysis module 230 can assign a trend status of the drilling rig to be abnormal based on the standpipe pressure trend. The trend analysis module can 230 can repeat the trend tolerance inquiry for all drilling parameters. In embodiments where trend status is determined based on two or more drilling parameters, the trend analysis module 230 can determine a master trend status based on the trend status determined for each drilling parameter. For example, determining a master trend status can include comparing the trend statuses for drilling parameter, and if any trend status of any drilling parameter is abnormal, then the trend analysis module 230 can assign a master trend status of abnormal at that time point; alternatively, if all trend statuses of all drilling parameters at the time point are normal, then the trend analysis module 230 can assign a master trend status of normal at that time point. For example, if the trend status for a first drilling parameter (e.g., standpipe pressure) is normal and the trend status for a second drilling parameter (e.g., wellbore fluid flow rate) is abnormal, then the trend analysis module 230 can assign a master trend status of abnormal at that time point. Use of the term “master trend status” is used to distinguish from an individual trend status of a single drilling parameter, in embodiments where multiple drilling parameters are analyzed by the trend analysis module 230; however, it is contemplated that the “master trend status” can be referred to as “trend status” for purposes of the output of the trend analysis module 230.

The trend analysis module 230 can be configured to output stream 235 and optionally, stream 236.

The trend analysis module 230 can output a trend status for each time point in the series of time points that are associated with the stream 225 of cleaned rig data, as a stream 236 of trend analysis data containing a trend status for every time point in the cleaned time series real-time drilling data. In embodiments, the stream 236 can be sent to the user device 140 (e.g., directly from the trend analysis module 230 or via the alert module 270) for viewing of historical drilling data on the user device 140. In embodiments, each data point from the stream 236 can be displayed on the user device 140 in the form of a first indicator, a second indicator, and an optional third indicator. In some embodiments, the first indicator and the second indicator are sent to the user device 140 via an application programming interface (API).

In embodiments, the first indicator and the second indicator are generally configured to be visually depicted on a display of the user device 140. For example, the first indicator and the second indicator can be displayed on a graph of values of the wellbore characteristic, drilling parameter, or trend status of the wellbore characteristic or drilling parameter versus historical time. The first indicator can be a data point on the graph that represents the numerical value of the wellbore characteristic or drilling parameter at a point in historical time, and the second indicator can be a color or pattern of the data point that is indicative of the severity of the numerical value at the point in historical time.

In embodiments, the stream 236 that is sent to the user device 140 (e.g., directly from the trend analysis module 230 or via the alert module 270) can include a third indicator that is indicative of the rig state. The third indicator is generally configured to be visually depicted on the display of the user device 140. For example, the third indictor can be visually depicted or displayed on the same graph as the first indicator and the second indicator as an outline of the first indicator, e.g., an outline of the data point that represents the numerical value of the wellbore characteristic, drilling parameter, or trend status of the wellbore characteristic or drilling parameter.

The trend analysis module 230 can output a trend status for each time point in the series of time points that are associated with the stream 225 of cleaned rig data, as a stream 235 of trend analysis data containing a trend status for every time point in the stream 235. The stream 235 of trend analysis data can also contain the cleaned rig data corresponding to time points in the stream 235, and any values calculated for the trend analysis. The stream 235 of trend analysis data containing the trend statuses can be sent to the time segmented drilling data batch (TSDDB) generator module 240.

The time segmented drilling data batch (TSDDB) generator module 240 can be configured to generate a time segmented drilling data batch 245 that can be sent to the neural network module 250. The time segmented drilling data batch 245 can include the time series real-time drilling data, rig state, trend status received over the window of time. The window of time can be 1, 2, 3, 4, 5, 6, 7, 8, 9, 10, 11, 12, 13, 14, 15, 16, 17, 18, 19, 20, 25, 30, 35, 40, 45, 50, 55, 60, 65, 70, 75, 80, 85, 90, 95, or 100 minutes, for example. The window of time can be defined as an amount of time bounded by a zero (0) point time and a window boundary time. For example, for a window of time of 60 minutes, the zero (0) point time can be the point in time when the TSDDB generator module 240 begins accumulating the times series real-time drilling data received from stream 235, and the window boundary time can be 60 minutes after the point in time that is the zero (0) point time. The TSDDB generator module 240 is configured to accumulate the drilling data for the designated window of time, and in this explanatory example, for 60 minutes. The TSDDB generator module 240 is configured to then send all the time series real-time drilling data accumulated during the window of time as a time segmented drilling data batch (TSDDB) 245 to the neural network module 250.

The neural network module 250 can be configured to receive the time segmented drilling data batch 245 from the TSDDB generator module 240. The neural network module 250 can be further configured to perform at least one deep learning model on an input data-set comprising the time segmented drilling data batch 245 and the stream 235 of trend analysis data to obtain an output data-set or stream of output data 255 comprising the drilling dysfunction prediction of the downhole characteristic associated with the wellbore environment, the predicted values for any wellbore characteristic, and any of the received data. “Downhole characteristic,” “drilling dysfunction”, and “drilling dysfunction prediction” are defined herein, where drilling dysfunction is relative to the downhole characteristic, and drilling dysfunction prediction is relative to the drilling dysfunction. In embodiments, the output data-set or stream of output data 255 can include a drilling dysfunction prediction, a drilling dysfunction, and a wellbore characteristic associated with each point in time of stream 235 of trend analysis data.

Each deep learning model in the neural network module 250 is present in the form of at least one neural network. Examples of neural networks suitable for use in the neural network module 250 include, but are not limited to, a single layer perceptron neural network, a multilayer perceptron neural network, a single layer feed forward neural network, a multilayer feed forward neural network, a convolutional neural network, a radial basis functional neural network, a recurrent neural network, a long short-term memory neural network, a sequence to sequence model, a modular neural network, multiple neural networks of the same type run in parallel, multiple neural networks of the same type stacked or run in series, multiple neural networks of different types run in parallel, multiple neural networks of different types stacked or run in series, or a combination thereof. In embodiments, the neural network module 250 contains a deep learning model suitable for time series forecasting.

The deep learning model can use the input dataset to predict drilling dysfunction, wellbore characteristic, or both, at a future point in time (e.g., the next time boundary for the window of the TSDDB) or for a stream of time-series future points in time (e.g., 1, 5, 10, 20, 30, 45, or 60 minutes into the future).

The neural network module 250 can be configured to analyze the TSDDB 245 to determine whether a drilling dysfunction of a wellbore characteristic is predicted. The deep learning model is trained on the drilling data with no presented drilling dysfunctions to learn and define a threshold for the loss function for the normal pattern. The neural network module 250 predicts a drilling dysfunction value for each TSDDB 245 and the value is compared with the defined threshold. The drilling dysfunction is presented if the predicted value is higher than the threshold. If a drilling dysfunction is predicted by the deep learning model, the neural network module 250 can be configured to associate the drilling dysfunction with the input dataset that have resulted in the dysfunction prediction. This association can be included in the output data set or stream of output data 255. The neural network module 250 can more than one deep learning model, with each deep learning model being trained and configured to predict a particular drilling dysfunction (e.g., a first deep learning model predicts a first drilling dysfunction, a second deep learning model predicts a second drilling dysfunction, where the first drilling dysfunction and the second drilling dysfunction are not the same dysfunction).

The neural network module 250 can be configured to generate a drilling dysfunction prediction indicator value (e.g., 0 or 1 for binary indication: 0 for no and 1 for yes, or vice versa) based on the deep learning analysis, associate the indicator value with the drilling dysfunction prediction, and include this indicator and the association with the prediction in the output data-set or stream of output data 255.

The neural network module 250 can also contain one or more loss functions that are configured to determine deviations of the dysfunction prediction(s) from the actual value(s) for the drilling parameter and/or wellbore characteristic that are later measured and received in the neural network module 250. Integrating one or more loss functions into the neural network module 250 helps to reduce error in the drilling dysfunction predictions that are generated in the neural network module 250, because the deviations can be continuously, periodically, or continuously and periodically fed to the deep learning model for learning of the deep learning model. In some embodiments, the deviations can be stored by the drilling dysfunction prediction computer 130 for retraining of the deep learning model.

Loss functions that can be included in the neural network module 250 can include regression type-loss functions, classification-type loss functions, or combinations thereof. Regression-type loss functions can include mean absolute error loss (also known as L1 loss), mean square error loss (also known as L2 loss and quadratic loss), mean bias error loss, or a combination thereof. Classification-type loss functions can include multiclass SVM loss (also known as hinge loss), cross entropy loss (also known as negative log loss), or a combination thereof

In embodiments, each drilling dysfunction prediction is determined by the neural network module 250 for the TSDDB 245.

In embodiments, the deep learning model is a trained deep learning model, and performing the deep learning model on the input data-set can include performing the trained deep learning model on the input data-set.

In some embodiments, the drilling dysfunction prediction computer 130 can be configured to retrain the trained deep learning model of the neural network module 250 at least once per year. The deep learning model can be retrained with a collection of most recent time series real-time drilling data collected by the database 120 or another database over a past time period, such as 1, 2, 3, 4, 5, 6, 7, 8, 9, 10, 11, or 12 months. The deep learning model can be additionally retrained with a collection of drilling dysfunctions events/data collected by the drilling dysfunction prediction computer 130 or another database over a past time period, such as 1, 2, 3, 4, 5, 6, 7, 8, 9, 10, 11, or 12 months.

The drilling dysfunction prediction computer 130 can be configured to send the output data set or stream of output data 255 to the severity mapping module 260. The severity mapping module 260 is configured to determine a severity of each dysfunction prediction in the stream 255 of output data, and to classify or map the severity to a severity level. The severity levels can be a range of levels, for example, level 1, level 2, level 3, and so on to level N, where each level indicates an amount of severity. It may be appropriate in some embodiments to assign the lowest severity as level 1 and the highest severity as level N, such as level 4.

The severity mapping module 260 can determine a severity of a drilling dysfunction prediction by comparing the predicted dysfunction values for the associated drilling parameter(s) and/or wellbore characteristic(s) with threshold severity values, and assigning a severity level based on the difference in values. Threshold severity values can be predefined and loaded into the drilling dysfunction prediction computer 130 (e.g., via the severity mapping module 260). For example, a predicted drilling dysfunction for stuck pipe is based on the deep learning model trained for stuck pipe for the TSDDB 245 along with the trend statuses for drilling parameters related with stuck pipe. For purposes of an exemplary discussion, a predicted dysfunction value (0.9) for stuck pipe is above severity threshold (0.8) for stuck pipe at predicted time 10 minutes into the future.

The severity mapping module 260 can be configured to send the predicted severity output 265 directly to the user device 140; alternatively, the severity mapping module 260 can be configured to send the predicted severity output 265 to the alert module 270; alternatively, the severity mapping module 260 can be configured to send the predicted severity output 265 to both the user device 140 and to the alert module 270.

The predicted severity output 265 that is sent to the user device 140 (e.g., directly from the severity mapping module 260 or via the alert module 270) can include a first indicator that is indicative of a value of the downhole characteristic associated with the window of time and the second indicator is indicative of the severity of the dysfunction prediction associated with the window of time. In some embodiments, the first indicator and the second indicator are sent to the user device 140 via an application programming interface (API).

In embodiments, the first indicator and the second indicator are generally configured to be visually depicted on a display of the user device 140. For example, the first indicator and the second indicator can be displayed on a graph of values of the wellbore characteristic or drilling parameter versus time. The first indicator can be a data point on the graph that represents the numerical value of the wellbore characteristic or drilling parameter at a point in time, and the second indicator is a color or pattern of the data point that is indicative of the severity of the numerical value.

In embodiments, the predicted severity output 265 that is sent to the user device 140 (e.g., directly from the severity mapping module 260 or via the alert module 270) can include a third indicator that is indicative of the rig state. The third indicator is generally configured to be visually depicted on the display of the user device 140. For example, the third indictor can be visually depicted or displayed on the same graph as the first indicator and the second indicator as an outline of the first indicator, e.g., an outline of the data point that represents the numerical value of the wellbore characteristic or drilling parameter.

In parallel with obtaining drilling dysfunction prediction and severity thereof via flow through modules 210, 202, 230, 240, 250, and 260, the monitoring module 280 is configured to receive stream 216, and to analyze the received data for informational changes of the rig or wellbore environment as predefined by a client of the drilling dysfunction prediction computer 130 (e.g., a user of user device 140). For example, a client may want to know when the drillstring begins and stops moving in the wellbore, when the drillstring begins and stops rotating in the wellbore, when the pump beings and stops in the wellbore, or other informational characteristics of the wellbore environment. The drilling parameters(s) and/or wellbore characteristic(s) of interest can be selected, and/or any thresholds for any drilling parameters(s) and/or wellbore characteristic(s) can be predefined and implemented by an administrator of the drilling dysfunction prediction computer 130. The monitoring module 280 can be configured to send the selected drilling parameters(s) and/or wellbore characteristic(s) values, and/or any drilling parameter(s) and/or wellbore characteristic(s) that are outside thresholds for any drilling parameters(s) and/or wellbore characteristic(s) in a stream 285 of informational alerts to the alert module 270.

The alert module 270 is configured to receive the predicted severity output 265, to receive the stream 285 of informational alerts, and to send an alert output 275 to the user device 140. The alert output 275 can be sent via email, encrypted messaging, nonencrypted messaging, SMS, or any other messaging technique for delivering an alert electronically. Moreover, the alert output 275 can be sent to any number of user devices 140 according to any combination of delivery techniques known in the art with the aid of this disclosure.

In aspects where the first indicator, second indicator, and optional third indicator are sent to the user device 140 via the alert module 270, the alert output 275 can contain the first indicator, second indicator, and optionally the third indicator, where each of these indicators is the same as that described for the severity output data 265.

The drilling dysfunction prediction computer 130 can be configured to store any data received by (time series real-time drilling data) and/or generated in (rig states, cleaned rig data, trend statuses, TSDDBs, calculated drilling parameters, determined wellbore characteristics, drilling dysfunction predictions, severity levels, associations between any of the data, alerts, information notifications, or combinations thereof) the drilling dysfunction prediction computer 130. The data can be stored in a datastore of the drilling dysfunction prediction computer 130, in the drilling database 120, or both.

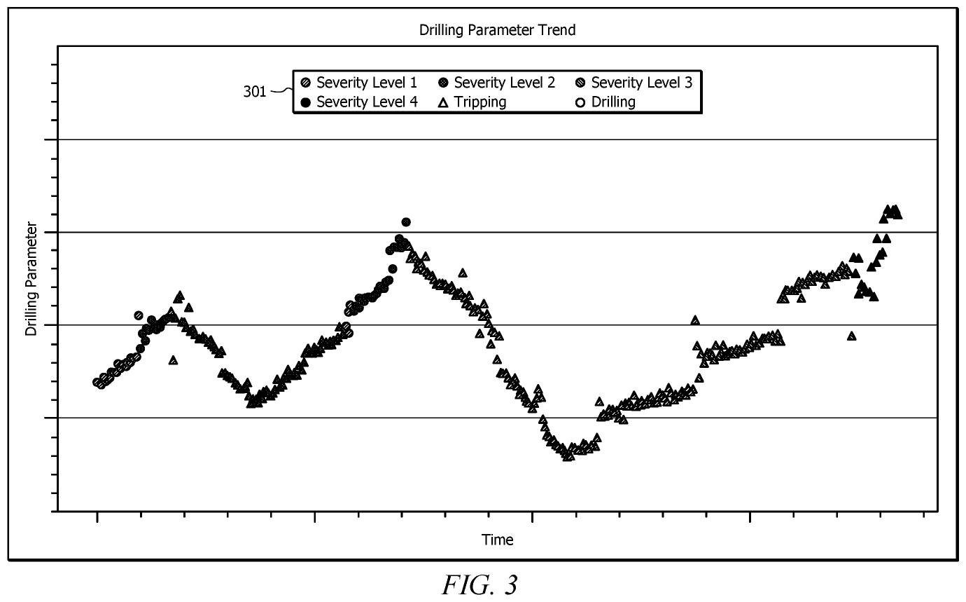

FIG. 3 illustrates a graph of drilling parameter (Y-axis) versus time (X-axis) for a wellbore environment, having data points displayed in a simplified manner according to the disclosure. This graph is an example of a visual display of historical trend data that can be output by the computer 130 for viewing on a user device 140 such as a smartphone. The drilling parameter for which values are illustrated in the graph of FIG. 3 is not particularly identified for proprietary purposes. The absolute numerical values for drilling parameter and time are also not displayed in the graph for proprietary reasons; however, it can be seen that drilling parameter values increase and decrease over time shown in FIG. 3.

The values for the drilling parameter shown in the graph are exemplary of the first indicator described herein. The pattern of the severity levels are exemplary of the second indicator described herein, and the shape of the outline (e.g., triangle or circle) are exemplary of the third indicator described herein. Each of the data points have all three indicators shown in the graph.

In the legend 301 in the graph, the severity levels can be seen: Severity Level 1, Severity Level 2, Severity Level 3, and Severity Level 4. Severity Level 1 is the first pattern, Severity Level 2 is the second pattern, Severity Level 3 is the third pattern, and with Severity Level 4 is the fourth pattern. Each of the data points on the graph can be seen as having one of the patterns of grayscale in the legend 301.

Also in the legend 301, the rig states can be seen. The rig states in the graph are tripping and drilling. Tripping is visually indicated by a triangle outline, and drilling is visually indicated by a circle outline. It can be seen that each of the data points on the graph has a triangle outline or a circle outline.

Each data point in the graph of FIG. 3 has three visual indicators: the historical data value plotted at the value for drilling parameter at the respective point in historical time, the pattern of the data point that is indicative of the severity level, and the outline of the data point being triangular or circular that is indicative of the rig state (either drilling or tripping).

The visual displays of conventional monitoring systems include a graph of a drilling parameter versus historical time with no information about the severity of the historical value or the rig state. Separate tables or graphs might include information about other drilling parameters; however, there is conventionally no way to view the severity of a drilling parameter value or the rig state, much less view the information on a single screen, much less having a drilling parameter, severity of the value, and rig state information on a single visual point on a graph.

Display of the indicators as shown in FIG. 3 is particularly useful on a user device 140 that is a smart phone or tablet having a smaller visible area. A user, which can be any drilling personnel, can zoom-in on a portion of the graph to see one or more isolated data points, so that the first, second, and third indicators can be clearly seen in one view on the screen of a smartphone or tablet.

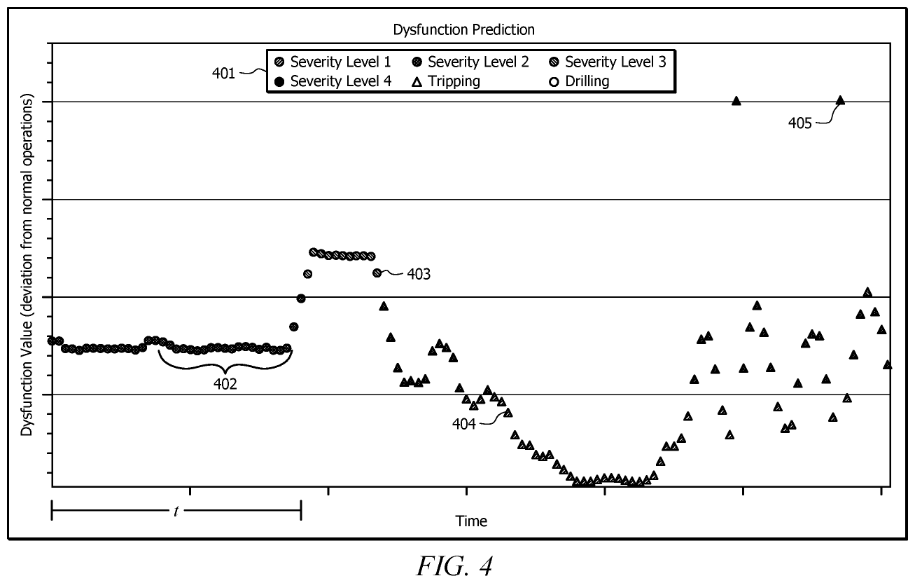

FIG. 4 illustrates a graph of dysfunction value (Y-axis) versus future time (X-axis) for a wellbore environment, having data points displayed in a simplified manner according to the disclosure. This graph is an example of a visual display of the first indicator, second indicator, and third indicator for dysfunction prediction, viewable on a user device 140 such as a smartphone. The absolute numerical values and future time are not displayed in the graph for proprietary reasons; however, it can be seen that the predictive dysfunction values increase and decrease over time into the future as shown in FIG. 4.

The values for predicted dysfunction shown in the graph are exemplary of the first indicator described herein. The pattern of the severity levels are exemplary of the second indicator described herein, and the shape of the outline (e.g., triangle or circle) are exemplary of the third indicator described herein. Each of the data points have all three indicators shown in the graph.

In the legend 401 in the graph, the severity levels can be seen: Severity Level 1, Severity Level 2, Severity Level 3, and Severity Level 4. Severity Level 1 is the first pattern, Severity Level 2 is the second pattern, Severity Level 3 is the third pattern, and Severity Level 4 is the fourth pattern. Each of the data points on the graph can be seen as having one of the patterns in the legend 401.

Also in the legend 401, the rig states can be seen. The rig states in the graph are tripping and drilling. Tripping is visually indicated by a triangle outline, and drilling is visually indicated by a circle outline. It can be seen that each of the data points on the graph has a triangle outline or a circle outline.

Each data point in the graph of FIG. 4 has three visual indicators: the data value plotted at the value for predicted disfunction at the respective point in time, the pattern of the data point that is indicative of the severity level, and the outline of the data point being triangular or circular that is indicative of the rig state (either drilling or tripping).

The visual displays of conventional monitoring systems include a graph of a drilling parameter versus historical time with no information about a predicted dysfunction, the severity of the predicted dysfunction into the future time, or the rig state into the future time. Separate tables or graphs might include information about other predicted dysfunctions (e.g., in embodiments where the neural network module 250. There is conventionally no way to view the severity of a predicted dysfunction or the rig state into a future time, much less any way to view the information on a single viewable screen, much less having a predicted dysfunction value, severity of the predicted dysfunction indicator, and rig state information on a single visual point on a graph.

Display of the indicators as shown in FIG. 4 is particularly useful on a user device 140 that is a smart phone or tablet having a smaller viewing area. A user, which can be any drilling personnel, can zoom-in on a portion of the graph to see one or more isolated data points, so that the first, second, and third indicators can be clearly seen in one view on the screen of a smartphone or tablet.

Data points 402 have dysfunction values that are in Severity Level 2 at points in future time, and the rig state is a circular outline of the data points, which according to the legend 401, means the rig state of drilling. Data point 403 has a dysfunction value that is in Severity Level 3 at a point further along in future time, and the rig state is a circular outline that indicates drilling. Data point 404 has a dysfunction value that is in Severity Level 1 at a point further along in future time, and the rig state is a triangular outline that indicates tripping. Data point 405 has a dysfunction value that is higher than any of data points 402, 403, and 404. The dysfunction value for data point 405 has a Severity Level 4, and the rig state is a triangular outline that indicates tripping.

The predicted dysfunction values in the graph of FIG. 4 indicate that after a period of time “t” into the future, if drilling continues under the conditions, that dysfunction is more likely to occur after time “t” into the future, since the data values jump to higher dysfunction values at Severity Level 3. Personnel monitoring the prediction on a user device 140 can take action to avoid the dysfunction moving to an unacceptable Severity Level 3 (assuming that Severity Level 3 is to be avoided in this example) after time “t” of drilling. Moreover, this graph and this collection of information is viewable on a single screen of the user device 140, so that predicted dysfunction is identifiable by personnel of a broad range of experience and skill levels.

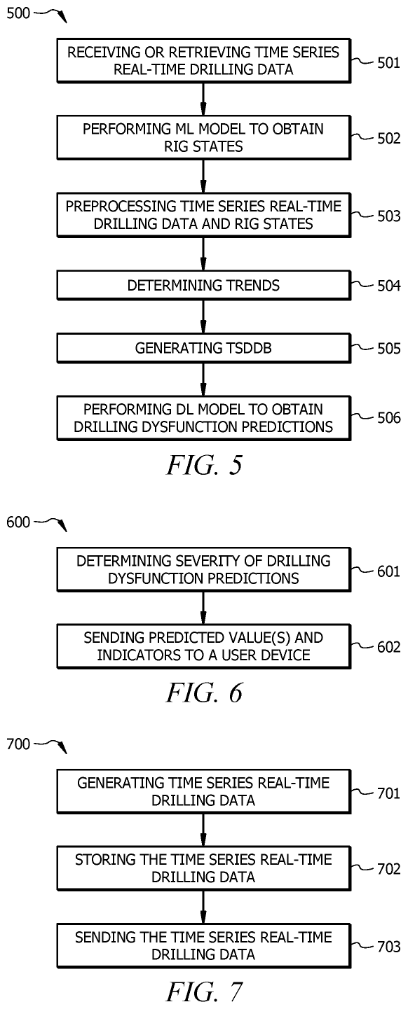

FIG. 5 illustrates a flow diagram of the disclosed method 500 for converting time series real-time drilling data into a dysfunction prediction of a downhole characteristic in a wellbore environment. The method 500 can generally include any of the functionality of the components 110, 120, 130, and 140 of the computer system 100 disclosed herein, and is described with reference to the reference numerals in FIGS. 1 and 2.

In block 501, the method 500 includes receiving or retrieving a stream 115/125 of the time series real-time drilling data. In embodiments, the drilling dysfunction prediction computer 130 receives or retrieves the stream 115/125 of the time series real-time drilling data. Method step 501 can be more particularly embodied as receiving or retrieving stream 115/125 by the machine learning model 210.

In block 502, the method 500 includes performing a machine learning model on the received or retrieved stream 115/125 of time series real-time drilling data to obtain a stream 215 of rig states. Stream 216 of rig states can also be obtained by the machine learning model. Method step 502 can be performed by the machine learning module 210 of the drilling dysfunction prediction computer 130. Other embodiments, aspects, and details of performing the machine learning model are discussed hereinabove and are not reproduced here.

In block 503, the method 500 includes preprocessing the stream 215 of rig states to obtain a stream 225 of cleaned rig data. Method step 503 can be performed by the data processing module 220 of the drilling dysfunction prediction computer 130. Other embodiments, aspects, and details of preprocessing are discussed hereinabove and are not reproduced here.

In block 504, the method 500 includes determining trends of at least one drilling parameter in the stream 225 of cleaned rig data to obtain a stream 235 of trend analysis data containing trend statuses, optionally the cleaned rig data corresponding to time points in the stream 235, and optionally any values calculated for the trend analysis. In embodiments of the method 500, determining trends can include calculating standpipe pressures, hook loads, torques, and wellbore fluid flow rates for the cleaned rig data to obtain the stream 235 of trend analysis data containing trend statuses. Method step 504 can be performed by the trend analysis module 230 of the drilling dysfunction prediction computer 130. Other embodiments, aspects, and details of determining trends are discussed hereinabove and are not reproduced here.

In block 505, the method 500 includes generating a time segmented drilling data batch (TSDDB) 245 comprising the data from stream 235 received over a window of time. Method step 505 can be performed by the TSDDB generator module 240 of the drilling dysfunction prediction computer 130. Other embodiments, aspects, and details of generating the TSDDB 245 are discussed hereinabove and are not reproduced here.

In block 506, the method 500 includes performing a deep learning model on an input dataset comprising the time segmented drilling data batch 245 obtained in block 505 and the stream 235 of trend analysis data obtained in block 504, to generate an output data set or a stream of output data 255 comprising the dysfunction prediction of the downhole characteristic associated with the wellbore environment. The deep learning model of the neural network module 250 of the drilling dysfunction prediction computer 130 can be configured to generate the output dataset or a stream of output data 255. In embodiments, and as discussed in more detail hereinabove, the deep learning model can be a trained deep learning model, and the method 500 can further include retraining the trained deep learning model at least once per year with a collection of the time series real-time drilling data collected over a past time period. Other embodiments, aspects, and details of performing the deep learning model are discussed hereinabove and are not reproduced here.

FIG. 6 illustrates a flow diagram of optional steps of the method 500 that can be performed after the output data set or a stream of output data 255 is generated.

In block 601, the method 500 can further include determining a severity of the dysfunction prediction of the downhole characteristic. The severity mapping module 260 of the drilling dysfunction prediction computer 130 can determine the severity. Severity determination is discussed in detail hereinabove and said discussion is not reproduced here.

In block 602, the method 500 can further include sending a first indicator and a second indicator for the downhole characteristic to a user device 140. Method step 602 can be performed by the severity mapping module 260 and/or by the alert module 270 as described hereinabove. As discussed above, the first indicator is indicative of a value of the downhole characteristic associated with the window of time and the second indicator is indicative of the severity of the dysfunction prediction associated with the window of time. In embodiments, the first indicator and the second indicator are sent to the user device 140 via an application programming interface (API). In additional embodiments, the first indicator and the second indicator are visually depicted on a graph that is displayed on the user device 140, wherein the first indicator is a data point on the graph, and the second indicator is a color or pattern of the data point. In these embodiments, the method can also include sending a third indicator indicative of the rig state to the user device 140, wherein the third indicator is visually depicted on the graph as an outline of the data point. Other embodiments, aspects, and details of sending indicators to the user device 140 are discussed in detail hereinabove and said discussion is not reproduced here.

FIG. 7 illustrates a flow diagram of optional steps of the method 500 that can be performed before the modules 210, 220, and 240, and 280 of the drilling dysfunction prediction computer 130 receive or retrieve the time series real-time drilling data. Generally, steps 701, 702, and 703 are performed by components 110 and 120 of the computer system 100.

In block 701, the method 500 can include generating the time series real-time drilling data. The time series real-time drilling data is generated by the drilling data computer system 110 in the manner described hereinabove, and this description is not reproduced here.

In block 702, the method 500 can include storing the time series real-time drilling data in a drilling database 120. Storage of the time series real-time drilling data and the drilling database 120 are described hereinabove.

In block 703, the method 500 can include sending the time series real-time data from the database 120 to the machine learning model in the machine learning module 210, the data processing module 220 for preprocessing, and the time segmented drilling data batch generator module 240 for generating the time segmented drilling data batch 245.

The method 500 can include additional embodiments, aspects, and details of the data, timing of steps or functions, and physical hardware that are discussed above for the computer system 100 and the drilling dysfunction prediction computer 130, for example: 1) the drilling parameter can be a standpipe pressure, a hook load, a flow rate of a wellbore fluid, or a combination thereof; 2) the downhole characteristic can be a stuck pipe; 3) each of the trend statuses is normal or abnormal; 4) each of the rig states is drilling, tripping in, tripping out, rotary drilling, slide drilling, tripping in, tripping out, circulating, connection, static, washing, pulling out of the hole, running in the hole, reaming up, and reaming down; 5) the window of time is from about 1 minute to about 1 hour; 6) the machine-learning model comprises a decision tree-based machine learning algorithm; 7) the deep learning model with native support for sequences fits for time series forecasting problems; 8) the accuracy of prediction using the method can be any accuracy disclosed herein, such as greater than 60%; 9) the time series real-time drilling data can be generated in an unconventional onshore wellbore; 10) any other feature or aspect discussed above for the computer system 100 and the drilling dysfunction prediction computer 130; or 11) combinations of 1)-10).

While portions of the disclosure illustrated in the various figures can be illustrated as individual components, such as computers or modules, that implement described features and functionality using various objects, methods, or other processes, the disclosure can also include a number of other computers, sub-modules, third-party services, and other components. Conversely, the features and functionality of various components can be combined into single components, as appropriate. Thresholds used to make computational determinations can be statically, dynamically, or both statically and dynamically determined.

What is claimed is:

1. A method for converting time series real-time drilling data into a dysfunction prediction of a downhole characteristic in a wellbore environment, the method comprising:
receiving or retrieving a first stream comprising the time series real-time drilling data;
performing a machine-learning model on the first stream to obtain rig states and to output a second stream comprising the time series real-time drilling data and the rig states;
preprocessing the second stream to obtain a third stream comprising cleaned rig data and the rig states;
determining trends of at least one drilling parameter in the third stream to obtain a fourth stream of trend analysis data comprising trend statuses, the cleaned rig data, and the rig states;
generating a time segmented drilling data batch comprising the trend analysis data received over a window of time; and
performing a deep learning model on the time segmented drilling data batch to obtain the dysfunction prediction and to output a fifth stream comprising the dysfunction prediction of the downhole characteristic associated with the wellbore environment.

2. The method of claim 1, further comprising:
determining a severity of the dysfunction prediction of the downhole characteristic; and
sending a first indicator and a second indicator for the dysfunction prediction to a user device, wherein the first indicator is indicative of a value of the dysfunction prediction associated with the window of time and the second indicator is indicative of the severity of the dysfunction prediction associated with the window of time.

3. The method of claim 2, wherein the first indicator and the second indicator are sent to the user device via an application programming interface (API).

4. The method of claim 2, wherein the first indicator and the second indicator are visually depicted on a graph that is displayed on the user device, wherein the first indicator is a data point on the graph, and the second indicator is a color or pattern of the data point.

5. The method of claim 4, further comprising:
sending a third indicator indicative of the rig state to the user device, wherein the third indicator is visually depicted on the graph as an outline of the data point.

6. The method of claim 1, wherein the at least one drilling parameter comprises of a standpipe pressure, a hook load, a flow rate of a wellbore fluid, or a combination thereof.

7. The method of claim 6, wherein the downhole characteristic is a stuck pipe or washout.

8. The method of claim 1, wherein each of the trend statuses is normal or abnormal.

9. The method of claim 1, wherein each of the rig states is rotary drilling, slide drilling, tripping in, tripping out, circulating, connection, washing, pulling out of the hole (POOH), running in the hole (RIH), reaming up, or reaming down.

10. The method of claim 1, wherein the window of time is from about 1 minute to about 1 hour.

11. The method of claim 1, wherein determining trends comprises:
calculating standpipe pressures, hook loads, torques, and wellbore fluid flow rates for the cleaned rig data to obtain the stream of trend analysis data containing trend statuses.

12. The method of claim 1, wherein the deep learning model is a trained deep learning model, the method further comprising:
retraining the trained deep learning model at least once per year with a collection of the time series real-time drilling data collected over a past time period.

13. The method of claim 1, wherein the machine-learning model comprises a decision tree-based machine learning algorithm.

14. The method of claim 1, wherein preprocessing the stream of real-time drilling data comprises capping minimum value of a drilling parameter, capping a maximum value of a drilling parameter, filling a gap in the time series values for a drilling parameter, removing an impossible value for a drilling parameter, ignoring any data carried over from a previous well based on hole depth, normalizing data values between 0 and 1, or combinations thereof.

15. The method of claim 1, further comprising:
sending a first indicator, a second indicator, and a third indicator for the at least one drilling parameter or the wellbore characteristic to a user device, wherein the first indicator is indicative of a value of the at least one drilling parameter or wellbore characteristic, wherein the second indicator is indicative of the severity of the value of the at least one drilling parameter or wellbore characteristic, and wherein the third indicator indicative of the rig state;
wherein the first indicator, the second indicator, and the third indicator are visually depicted on a graph that is displayed on the user device, wherein the first indicator is a data point on the graph, and the second indicator is a color or pattern of the data point, and the third indicator is an outline of the data point.

16. The method of claim 1, wherein the time series real-time drilling data is generated in an unconventional onshore wellbore.

17. The method of claim 1, further comprising:
generating the time series real-time drilling data;
storing the time series real-time drilling data in a database; and
sending the time series real-time data from the database to the machine learning model, a data processing module for preprocessing, and a time segmented drilling data batch generator module for generating the time segmented drilling data batch.

18. A computer system comprising:
a first computer device configured to:
receive or retrieve a first stream comprising the time series real-time drilling data;
perform a machine-learning model on the first stream to obtain rig states and to output a second stream comprising the time series real-time drilling data and the rig states;
preprocess the second stream to obtain a third stream comprising cleaned rig data and the rig states;
determine trends of at least one drilling parameter in the third stream to obtain a fourth stream of trend analysis data comprising trend statuses, the cleaned rig data, and the rig states;
generate a time segmened drilling data batch comprising the trend analysis data received over a window of time; and
perform a deep learning model on the time segmented drilling data batch to obtain the dysfunction prediction and to output a fifth stream comprising the dysfunction prediction of the downhole characteristic associated with the wellbore environment.

19. The computer system of claim 18, further comprising:
a data store networked with the first computer device and configured to store the time series real-time data and send the time series real-time data to the first computer device.

20. The computer system of claim 19, further comprising:
a second computer device networked with the database and configured to generate the time series real-time drilling data.
